(19) United States
(12) Patent Application Publication
(10) Pub. No.: US 2023/0340936 A1
(43) Pub. Date: Oct. 26, 2023

(54) Vertical Axis Turbine with Augmented Guided Vane for Marine Applications

(71) Applicant: Hossam Gaber, North York (CA)

(72) Inventors: Hossam Gaber, North York (CA); Ahmed Ramadan Mohamed, CAIRO (EG)

(21) Appl. No.: 17/727,763

(22) Filed: Apr. 24, 2022

(51) Int. Cl. F03B 13/22

(52) U.S. Cl. CPC F03B 13/22; F05B 2220/32; F05B 2240/12; F05B 2250/713

(57) ABSTRACT

A turbine with a vertical axis (Savonius type) with S shape blade is conducted in this design after a modification in the design of the blade (SSWT). An enclosure guiding plate is attached to the rotor and fixed through the whole of the blade in the middle of it. It is stacked to the blade and rotates as one unit with the blade. This configuration doesn't need special installation as a guiding plate. This guiding plate is made with 11% of the blade diameter and makes an angle 30° with the blade surface. This guiding plate is made on one side of the blade's surface on every face. The tip of the guiding plate is toward the pressure side of the advanced side. SSWTs are originally considered very promising, before being superseded by the present horizontal-axis turbines. For various reasons, there is now a resurgence of interest in SSWTs, in particular, Savonius turbines with S shape blades (SSWT). Since SSWTs show many specific advantages (compact design, easier connection to gears/generator, easier blade control if needed. This design increases the total efficiency of the turbine to be more than 21% for the water stream energies extracted than other designs.

### REFERENCE CITED

### U.S. Patent Documents

U.S. Pat. No. 4,551,631 A, Rowe
U.S. Pat. No. 7,762,777 B2; Vanderhye et al.
U.S. Pat. No. 4,784,568; Benesh.
U.S. Pat. No. 9,024,463 B21; Boone.
U.S. Pat. No. 9,534,581 B2; Vanz.

### FOREIGN PATENT DOCUMENTS

EP 1 540 176 B1, Rowe.
DE102011100630A1; Mohamed et al.

### OTHER PUBLICATIONS

Mohamed M H, Janiga G, Pap E, Thevenin D. Optimization of Savonius turbines using an obstacle shielding the returning blade. Renew Energy November 2010; 35(11):2618-26.
Mohamed M H, Janiga G, Pap E, Thevenin D. Optimal blade shape of a modified Savonius turbine using an obstacle shielding the returning blade. Energy Convers Manag 2011; 52(1):236-42.
A. Ramadan, S. Y. Marzok, M. H. Mohamed, S. M. Abdien, A. El FEKY, and A. R. El-Baz “An Artificial Generation of Regular and Irregular Sea Wave: New Design Simulator and Experimental performance.” Energy 69 (2014) 309-318.
A. Ramadan, M. H. Mohamed, S. M. Abdien, S. Y. Marzouk, A. El Feky, and A. R. El Baz.” Analytical Investigation and Experimental Validation of an Inverted Cup Float Used for Wave Energy Conversion.” Energy 70 (2014) 539-546.
Kamoji, M. A., Kedare, S. B., Prabhu, S. V., 2008. “Experimental investigations on single stage, two stage, and three-stage conventional Savonius rotor.” Int. J. Energy Res. 32 (10), 877-895.
A. Ramadan, Mohamed A. A. Nawar, and M. H. Mohamed “Performance evaluation of a drag hydro kinetic turbine for rivers current energy extraction—A case study” Ocean Engineering Volume 195, 1 Jan. 2020.
A. Ramadan, K. Yousef, M. Said, and M. H. Mohamed “Shape optimization and experimental validation of a drag vertical axis wind turbine” Energy 151 (2018) 839-853.
A. Ramadan, M. Hemida, W. A. Abdel-Fadeel, W. A. Aissa, M. H. Mohamed “Comprehensive Experimental and Numerical Assessment of a Drag Turbine for River Hydrokinetic Energy Conversion” Ocean Engineering Volume 227, 14 Apr. 2021.

### BACKGROUND OF THE INVENTION

### Field of the Invention

The present invention is related to the field of hydrokinetic turbines, specifically to the vertical axis turbine having a concentric guiding plate to the S shape blade of Savonius (SSWT) type for redirection of the fluid flow forces to the advanced side of the blade.

### BACKGROUND

Conventional vertical axis Savonius turbines work based on the energy of the fluid flow speed to turn one or more blades around a rotor. The blades are connected to a vertical shaft mounted to a generator that spins to generate electricity. Savonius turbines are mounted on a tower or building roofs or under the surface of a water line to capture the most energy in a location to receive the full effects of the fluid flow yet not disturb the immediate environment. Savonius turbines are installed from 6 to 10 meters above the ground or building and under a water line of 5 cm. Savonius turbines consist generally of blades that rotate with respect vertically orientated axis. Fluid stream energy is fueled by the kinetic energy of the fluid, making wind and water streams a clean energy source. In general, wind and water stream turbines technologies have progressed rapidly and played a big role in renewable energy technologies. The Water current wave's energy is the most promising energy source in renewable energy due to the availability of sources in Canada during the whole year. Many patents and articles were worked on the implementation of a guide vane to increase the power of the vertical axis turbine. [001 and 002] are an example of the modification made in the Savonius turbine by conducting an annular array of stator vanes to direct wind into the rotor, they are shown in European patents with No. EP 1540176 B1 and U.S. Pat. No. 6,740,989B2 (ROWE).

Another example of the Savonius with guided vane is shown in U.S. Pat. No. 7,762,777, the Savonius vertical axis wind turbine rotor was conducted with at least three spokes, at least two vanes, and fasteners. Each spoke was included with a hub with a central opening and arcuate ribs integral with the hub and extending radially outwardly. Vanes of the sheet had an opening aligned with the channels. The guided vanes might overlap the central opening so that there was spillover from one vane to the next when the rotor was rotated by the wind. Moreover, [004] in this invention the author implemented a deflector assembly in the vertical axis Savonius-type rotor, which serves as an augmentation apparatus to increase the output power of the Savonius-type rotor and also improves the self-starting the patent No. is U.S. Pat. No. 4,784,568. [005] Another example of this configuration is in patent No. U.S. Pat. No. 9,024,463 B2 was designed with multiple rotor vanes disposed of symmetrically for rotation about the vertical shaft. Each vane is substantial box-shaped with four solid sides and a front and rear side disposed of in a radial vertical plane. The front side of each vane is substantially open-faced and the rear side has an opening covered by a plurality of flaps. Each of said flaps is capable of moving with the directional passage of fluid through the vane. [006 and 007] recently investigations were conducted to enhance the performance of the Savonius turbine using geometric optimization to get the S shape blade and an obstacle plates to guide the flow as external part in the turbine to increase the output power as Mohamed et al. They resulted in rising the power coefficient of the turbine to 25% at a tip speed 0.8 with optimum guided vanes positioned. [008] Mohamed has invented a new blade profile as S shape profile and augmented by two fixed external obstacles with certain angles under the Dutch patent No. DE 102011100630 A1. [009] Vaz invented a turbine with a method for guiding the fluid flow under patent No. U.S. Pat. No. 9,534,581 B2. The turbine includes a framework with an annular upper guide plate and an annular plate at the base as a guide one. This annular rotor assembly is surrounding the central space, the rotor assembly comprises a plurality of rotor vanes, each rotor vane is held in position between the upper guide plates and the base guide plates.

Savonius turbines with S shape blade (SSWT) are considered the simplest design of vertical axis turbines. Aerodynamically, it is sorting as drag-type turbines, forming one blade. The blade of the turbine works due to the difference in forces exerted on the blade. The advanced side of the blade captures the energy in the water stream and forces the blade to rotate around the center of the turbine. Whereas the advanced side of the blade is stroked by the fluid flow and causes the fluid to be deflected sideways around it. Hence, the advancing side of a blade which is facing the water flow will introduce more drag force than the returning side of the blade, and this effect leads the Savonius rotor to rotate. There are two parameters affecting the performance of any turbine; the torque coefficient Cₘ and the power coefficient Cₚ which are written as follows:

$${C}_{m} = \frac{T}{0.5 ρ {U}_{w}^{2} AR} \qquad ( 1 )$$

Where T is the average aerodynamic torque acting on the rotor shaft, ρ is the density of the water, U_{w} is the approaching fluid speed, A is the projected area of the turbine, and finally, R is the rotor radius.

$${C}_{p} = \frac{T ω}{0.5 ρ {U}_{w}^{3} A} \qquad ( 2 )$$

ω is the angular speed of the rotor.

The tip speed ratio of the turbine is defined as:

$$λ = \frac{R ω}{{U}_{w}} \qquad ( 3 )$$

Equation 2 can be rewritten as follows

Cₚ=λCₘ (4)

These terms of power and torque coefficients are calculated at different Reynolds numbers based on the approaching fluid speed U_{w} with kinematic viscosity ν and D the blade diameter.

$$Re = \frac{{DU}_{w}}{v} \qquad ( 5 )$$

According to the previous survey of patents and articles, the processing of implementation or execution of the guided vane is always externally and separated from the blade. It needs a complicated structure and a huge installation in size to get it is a function that is contrary to the proposed design. The generation and use of electric power for boats and ships in the case of waiting or being docked in the port is one of the massive problems due to the amount of fossil fuel consumed in the production of these engines for electrical power. The production of electricity from alternative or renewable energy sources is becoming necessary [010, 011, and 012].

A hydrokinetic turbine with a new design (SSWT turbine) with S shape blade [013, 014, and 015] is proposed to exploit the energy inflow of water current to be harvested directly into electrical energy for the required usage aboard vessels. This system must be simple installation and fixation on the board of ships and yachts with regarding the balance of them.

### SUMMARY OF THE INVENTION

The invention relates to a vertical axis turbine with endplates at the ends of the blade. Moreover, a blade with S shape is considered in this design (SSWT) and redesigned by inserting a guiding plate in the center of the blade. This plate is implemented through the chord of the blade. The S blade is chosen according to its high efficiency of it compared to conventional Savonius, this guiding plate is used to redirect the water stream to the advanced or pressure side of the blade. The main advantage of this invention design of the guided tip plate is rotating with the blade and orienting the fluid stream to the advanced side of the blade during the rotation of the blade. Therefore, the blade is captured more mass fluid in it and high torque can be produced due to that. The advantages of this innovative design can be broken into the following points:
Increasing the mass of a fluid to the advancing side of the blade increases the flow rate and output power.
The velocity of guided fluid flow is increased by the tip of the directed plate into the advanced blade which makes the pressure difference on the blade grow up rapidly.
Strengthen the blade to withstand the forces of fluid on it.
All these points lead to an increase in the torque output from low fluid speed incidents.
The highly efficient of the turbine at low water speed and low tip speed ratio.
The wide range of power curves for the turbine.
The self-starting of the turbine at low water speed.
The simplest design and manufacturing for this design.
The operating range of SSWT is wider than other types as can be seen in FIG. 6.

This guiding plate has a width that is 11% of the blade's diameter and is positioned in the center of the blade to implement throughout the blade's surface at the center. This ratio of 11% of the guiding vane plate's width to the blade's diameter is corresponds to the minimum surface that can be manufactured and is most compatible with the chosen angle to guide the fluid flow inside the blade not outside it. The plate is positioned at an angle 30° with the blade surface at the center of the blade to be a sharp angle to throw out the fluid and forced it to the advanced side of the blade. This will be increasing the output torque and directly increase the output power.

### BRIEF DESCRIPTION OF THE DRAWINGS

Embodiments of the invention will now be described, by way of example only, concerning the accompanying drawings as follow:

FIG. 1 is the isometric of the SSWT Design with Fluid Flow path.

FIG. 2 is the isometric Sections for FIG. 1 for the SSWT design with Fluid Flow path.

FIG. 3 shows the 2D Item Components for SSWT.

FIG. 4 describes a full Detailed Design of SSWT.

FIG. 5 to 6 depict the simulations of the invention design of S shape blade with 30° and 11% width with other blade designs, with comparison in the torque and power coefficients.

FIG. 7 to FIG. 16 show the pressure and velocity profiles for all designs.

### DETAILED DESCRIPTION

The full engineering design detail can be illustrated in a group of drawings as follows:

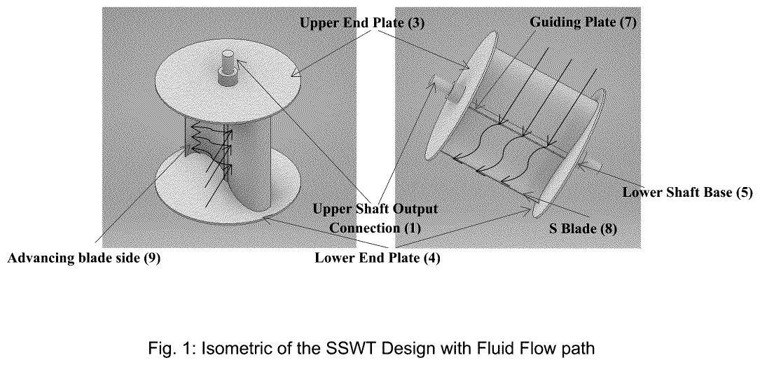

FIG. 1 is the isometric view as 3D of the turbine SSWT (S shape water turbine) of the fluid flow streaming lines and how they can redirect the fluid to the advanced side of the rotor blade. The SSWT is conducted by 10 parts as follow:
Part (1) Upper Shaft Output Connection. The upper connector shaft is implemented at the end plates disk in the upper one to connect directly to the electric generator or gearbox
Part (2) Lower Shaft Output Connection is needed to connect to the base bearing for fixation and smooth rotation with less noise in motion.
Parts (3, and 4) Upper and lower End Plates. They guide and concentrate the fluid flow to the core of the S shape blade directly to the advanced side by flowing the fluid to the guiding vane plate to increase the pressure difference on blade sides.
Parts (5, and 6) Shaft bases for the connecting between upper and lower output shafts with endplates and reinforce shafts during rotation and fixation.
Part (7) Guiding Plat. It is designed to redirect and center the fluid flow into the advanced blade side in the S shape blade turbine. One of the major things that the guided vane is the Reinforcement of the rotor in the center to withstand more forces and torques. The redirected fluid is coming from the tip of the guided vane and forcing the fluid to make 2 things:
   1. Focusing the fluid flow to one side of the rotor blade (advanced side).
   2. Increases the incident fluid's velocity, which increases the torque output.
Part (8) is the rotating blade in the form of S shape.
Part (9) is the advanced side of the S shape blade, which is responsible to capture the fluid flow coming from to make the torque needed for the power output. This side has a high-pressure zone in the turbine.
   3. Part (10) is the return side of the S shape blade. This part of the blade has the minimum value of pressure and assists the blade to rotate. In our innovative part, this side has the min. pressure because most of the fluid flow income is directed by the guide vane plate to the advanced side.

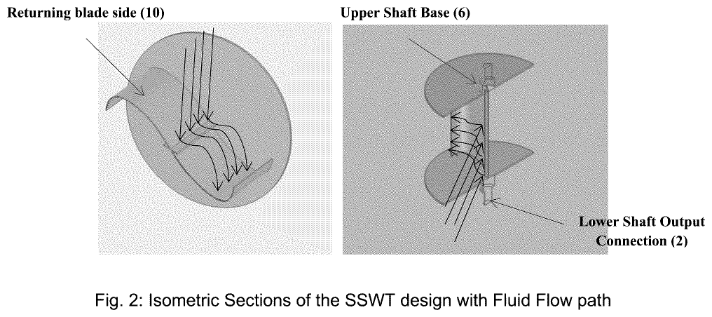

FIG. 2 is the sectional of the isometric design to clear the S shape blade profile and the fluid flow paths and how the orientation of the streaming lines are changed. The sections are taken in the z and y direction of the isometric drawing respectively. The guided vane is clearer in this figure how it is designed to be on one side of the blade and its tip is directed to the advanced side of the rotor blade.

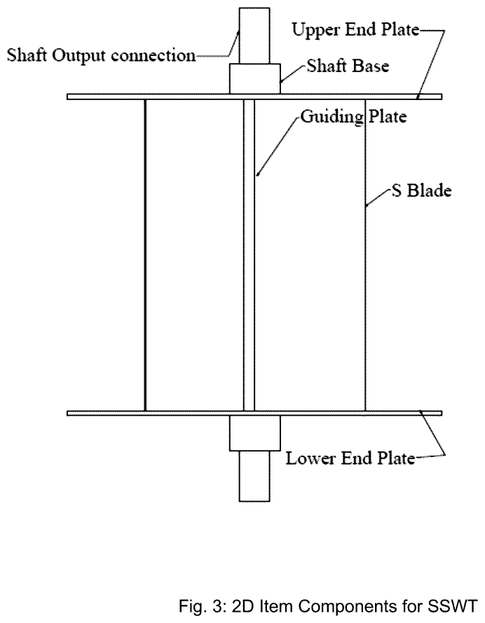

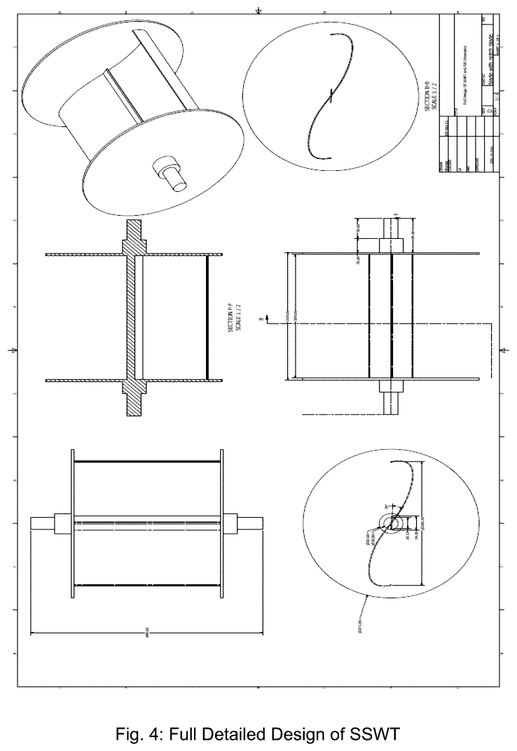

FIGS. 3 and 4 are showing the full engineering design of the SSWT turbine with detail.

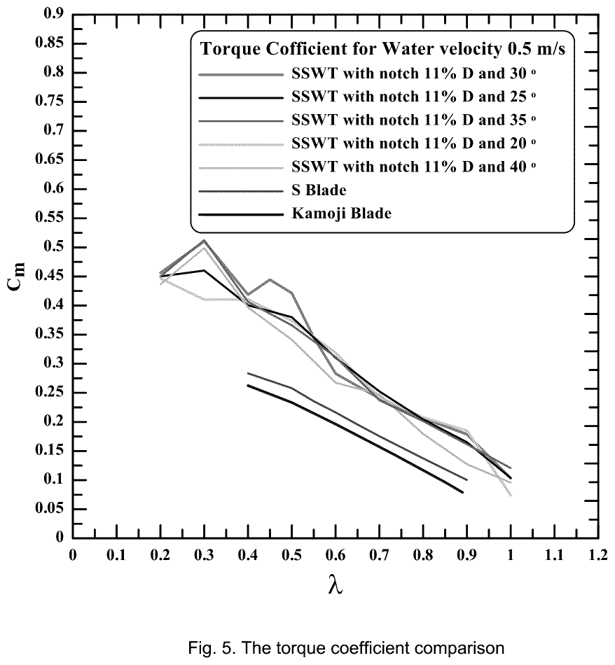

FIG. 5 is the result of torque coefficient output from the 2D simulation of the SSWT at water speed 0.5 m/s with different in guide vane angles (20°, 25°, 30°, 35°, and 40°).

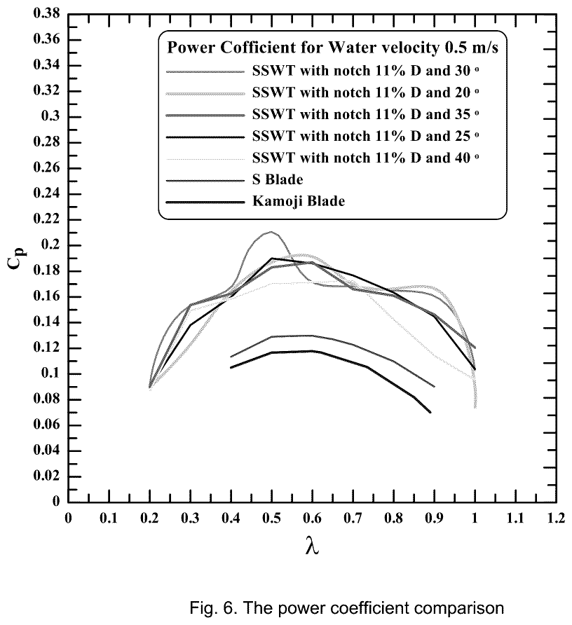

FIG. 6 is the output power coefficient comparison the five angles of SSWT with other turbines. It is clear how the SSWT is more efficient than the other 2 turbines especially with guide vane 30°. The SSWT turbine with 30° has power coefficient with 51% increase than other two turbines of Kamoji and S turbine.

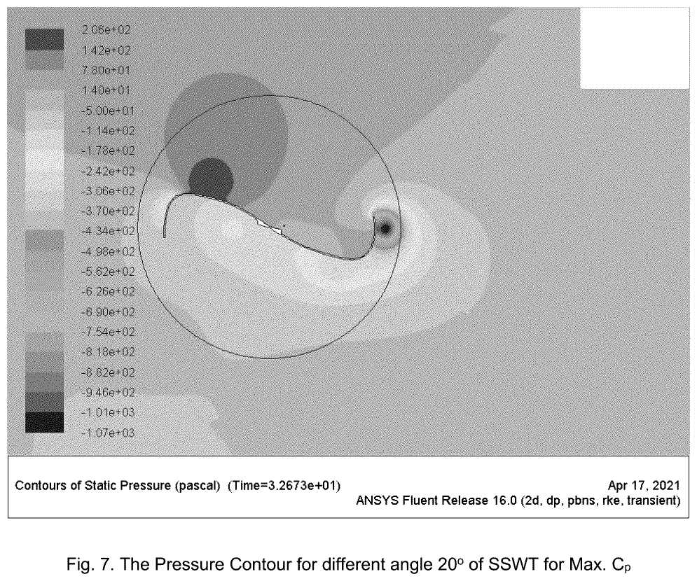

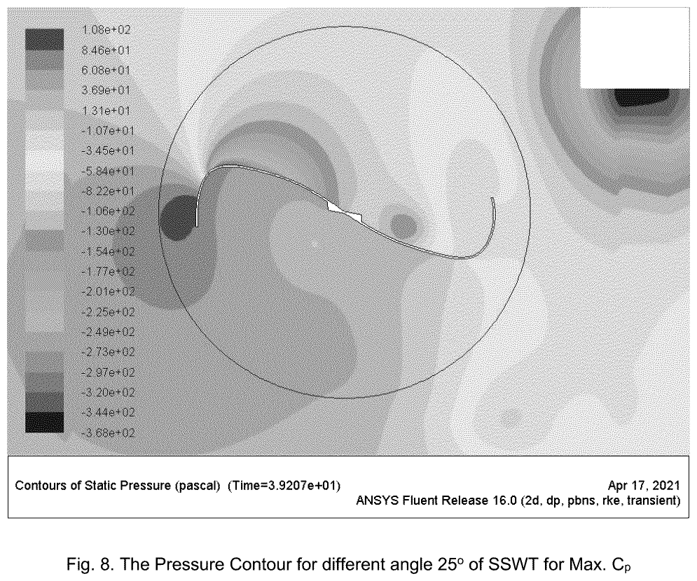

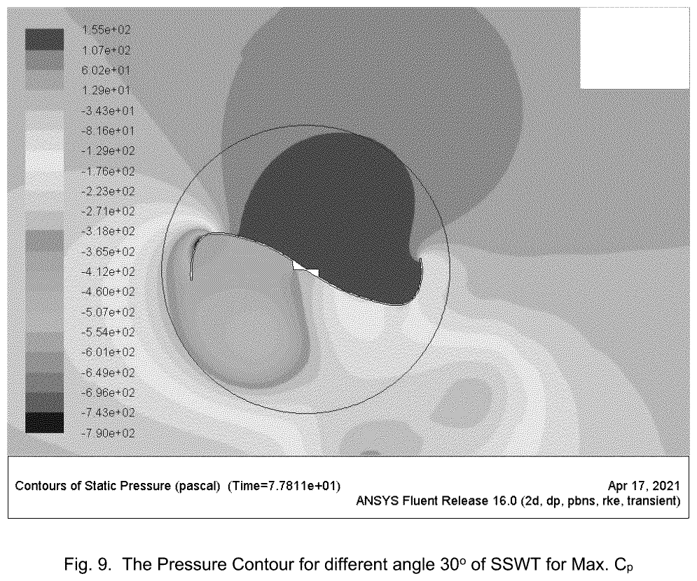

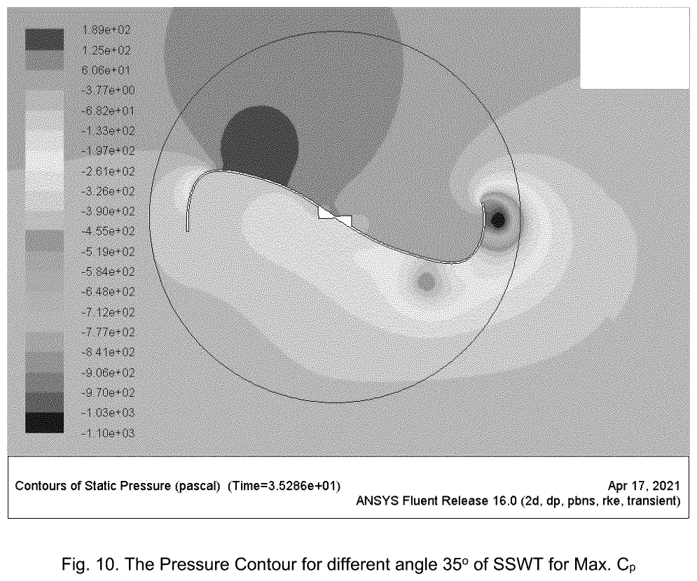

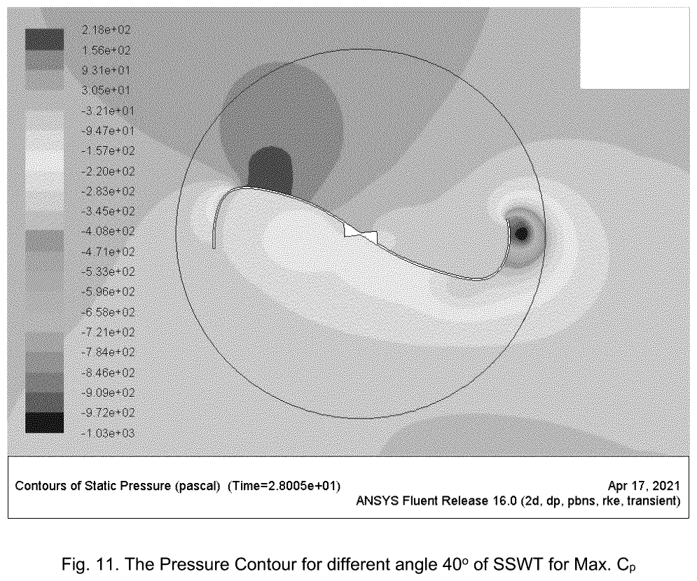

FIGS. 7-11 show the pressure value with 1.55×10² on the advanced side of the blade in 30° turbine compared to 7.8×10¹, 1.13×10¹, 6.06×10¹, and 3.05×10¹ for 20°, 25°, 35°, and 40° respectively.

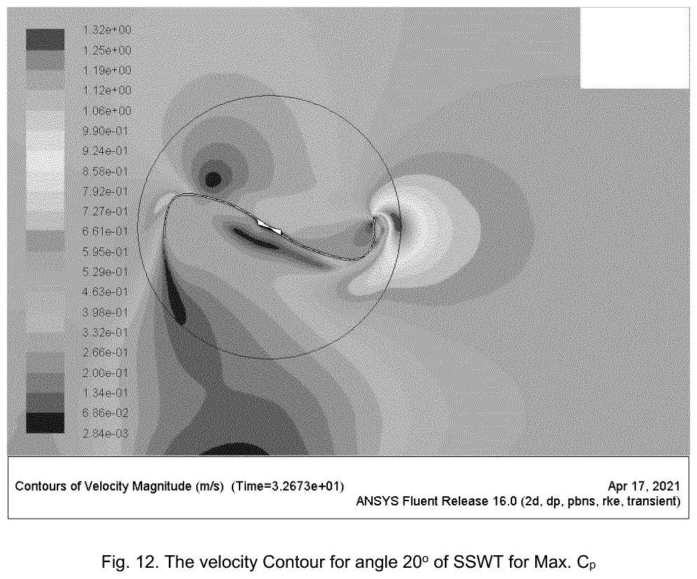

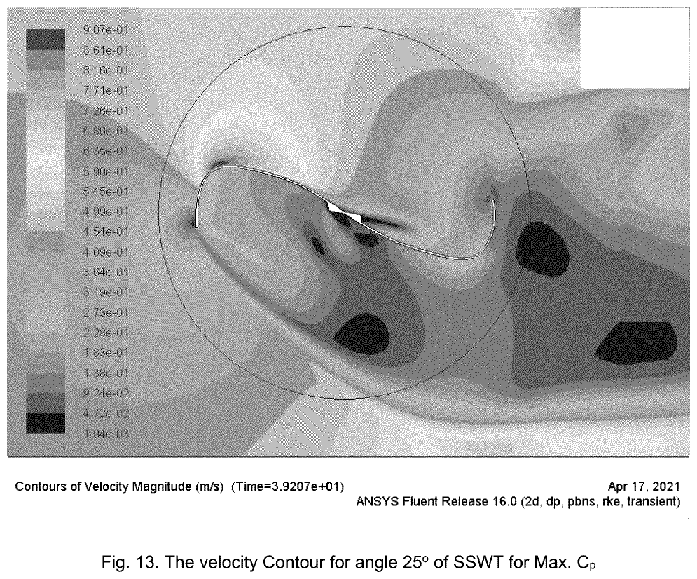

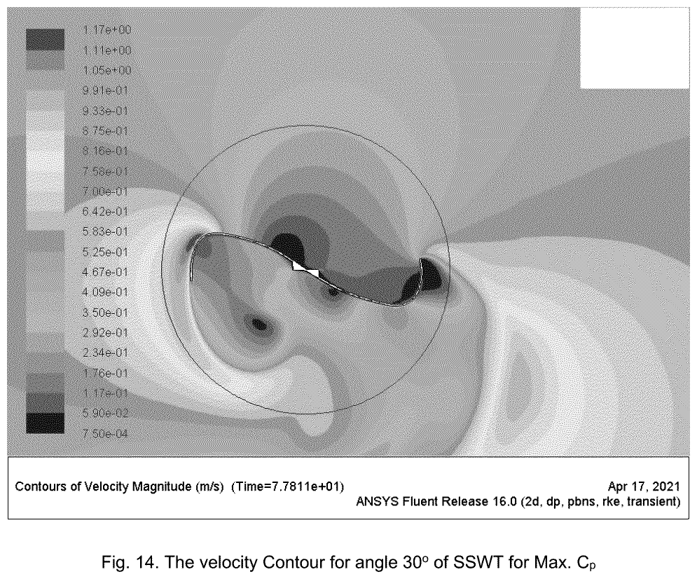

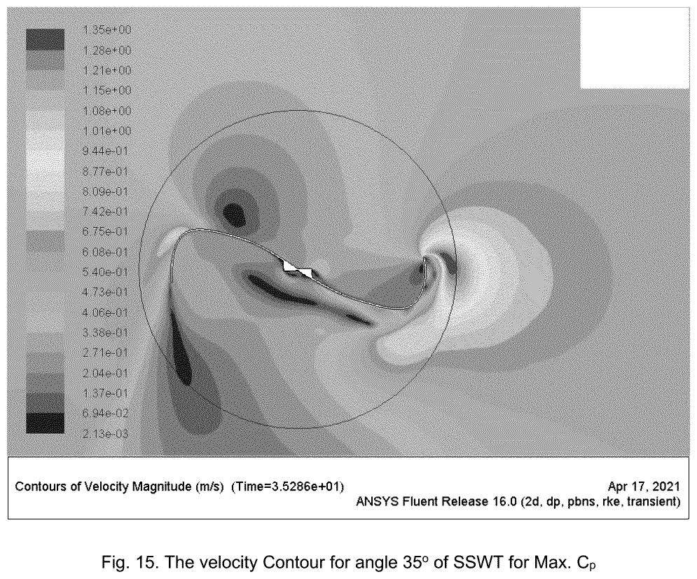

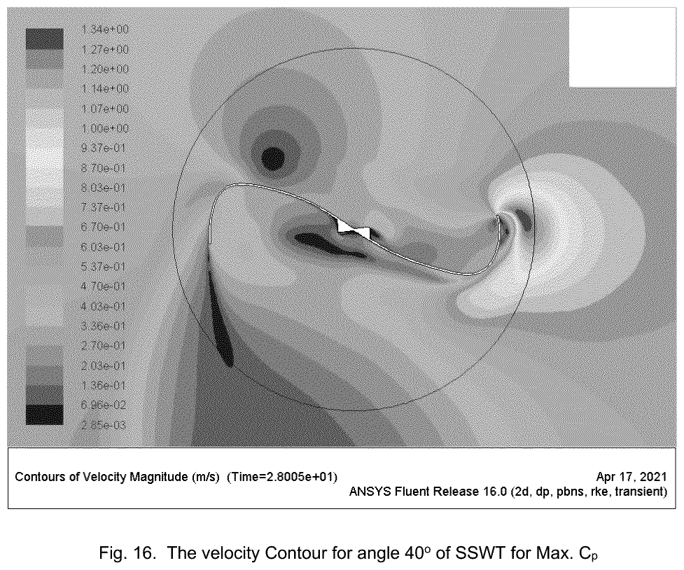

FIGS. 12-16 indicate the velocity contour between all design, which shows that the velocity on the advanced side in 30° turbine less than other designs by 7 times.

1. Guiding plates are inserted throughout the cord of the S rotor blade with end plates and the connector shaft. The angles of the guiding plates with the surface of the blade are 20°, 25°, 30°, 35°, and 40°. Their widths are 11% of the blade diameter. The conventional guiding vanes are typically installed external to the rotor as separated from the blade, which made it difficult to implement, as it has complex structure and a huge installation in size. The proposed design eliminates these complexities and offer improved performance.

2. As part of claim-1 wherein the guiding plate is designed to be as one unit with the rotating blade of the turbine, which offers a compact size and simplified manufacturing. The main advantage of this guiding plate is that it rotates with the blade and orienting the fluid stream to the advanced side of the blade during the rotation. Therefore, increasing the mass of the fluid to the advancing side of the blade, which increases the flow rate and output power.

3. As part of claim-2 wherein the guiding plate of 11% of blade width and 30° angle from the blade surface increases the efficiency of 50% more than the S shape turbine and 75% more than the conventional Savonius one.

4. As part of claim-1 wherein the connector shaft is implemented at the endplates on both sides to connect directly to the shaft of the electric generator. This position of the shaft increases the output power because there are no vortices formed on it from the fluid flow.

5. The S shape blade turbine is born from the Savonius turbine (drag turbine) after optimizing the blade shape geometry. This design contains an advanced side and a return side according to the direction of fluid flow, the S-shape reversed blade is that only a component of this concentrated force acts in a direction opposing rotor rotation. This gives preference to the S shape blade to capture more power than a regular Savonius turbine. This enhancement in power is due to the increased lifting force on the blade with highly negative pressure. The S shape blade is connected to end plates on both sides of the upper and lower sides. The end plates are in a disk shape with a diameter equal to 1.25 diameter of the S shape blade of the turbine. Moreover, the separation of flow is decreased because of that, there are no gaps in this design due to no shaft through the chord of the blade. Where the flow is moving smoothly. This means the turbine gets as much as possible from the fluid energy with low losses. Guiding vane plates are inserted throughout the chord of the S shape blade of the turbine. The innovatory of the guided vane plate is being a part of the blade and not separate like other designs. The guided vane plate is designed to be fabricated directly with the Shape blade at the same time; this is because it is a part of it.

6. As part of claim-1, the shaft connecting the S shape blade to the generator or gearbox is implemented on the surface of the end plates on both sides. This is designed instead of being in the blade's center through the whole chord as usual design. Thence, the guided vane palate is implemented instead of this blade shaft through the whole chord of the blade.

7. As part of claim-2 wherein the outer connector shaft of the blade is implemented at the endplates on both sides to connect directly to the electric generator. This position of the connector outer shafts increases the output power because there are no vortices formed on it from the fluid flow.

8. As part of claim 1 the guiding vane plate is designed and implemented with the S shape blade through the chord with an angle of 30° with the horizontal line of the S shape blade surface. This angle is measured from the surface line of the blade, which is the optimum one to enforce the fluid flow to be directed into the S shape blade surface smoothly, not outside it or concentric in one spot. This will increase the contact area between the fluid flow and the blade with the increase in the mass flow rate captured.

9. As part of claim-4, the width of the guided vane plate is 11% of the S shape blade diameter. This ratio is the most acceptable value to be manufactured with the S shape blade without any complication. Otherwise, it can be manufactured separately and then set up on the chord of the blade. This width ratio is optimum with an angle of 30° for the guide vane plate, it is directed the fluid to the blade with a very smooth flow without separation or away from the S shape blade surface.

10. As part of claim-4 wherein the guiding vane plate is designed to be as one unit with the rotating blade of the turbine, which offers a compact size and simplified manufacturing. The main advantage of this guiding plate is that it rotates with the blade and orients the fluid stream to the advanced side of the blade during the rotation. Therefore, increasing the mass of the fluid to the advancing side of the blade increases the flow rate and output power.

11. As part of claim-4, wherein the guiding vane plate of 11% of blade width and 30° angle from the S shape blade surface increases the efficiency by 50% more than the S shape blade turbine and 75% more than the regular Savonius turbine one.
